(19) United States
(12) Patent Application Publication
(10) Pub. No.: US 2006/0053494 A1
(43) Pub. Date: Mar. 9, 2006

(54) Embedded revocation messaging

(75) Inventors: Franciscus L A J Kamperman, Eindhoven (NL); Alphons A M L Bruekers, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., Eindhoven (NL)

(21) Appl. No.: 10/541,975

(22) PCT Filed: Dec. 19, 2003
(86) PCT No.: PCT/IB03/06290

§ 371 Date: Jul. 12, 2005

(30) Foreign Application Priority Data
Jan. 15, 2003 (US) 60440296

(51) Int. Cl. H04L 9/32

(52) U.S. Cl. 726/27

(57) ABSTRACT

An apparatus stores (60), transmits (1, 1′), or receives (2) a signal (5, 5′) representing user desired content (10, 10′, 10″, 10′″, 62) with device revocation information (4, 71) embedded in the user desired content. In a suitable transmitting embodiment (1, 1′), watermark content (20) including the device revocation information (4) is embedded in the user desired content (10, 10′, 10″, 10′″) during encoding as an embedded watermark In a suitable receiving embodiment (2), an embedded watermark (20) is read from the signal (5) representing the user desired content (10). The device revocation information (4) is extracted from the embedded watermark (20).

This application relates to the information processing arts. It finds particular application in the control of dissemination and use of copyrighted music and other recorded content through the use of device revocation lists, and will be described with particular reference thereto. However, the following will also find application more generally in controlling information transfer among networked devices, in providing improved property protection of music, video, software, data, and other information content, in combating proliferation of viruses and other malicious software code, and in other similar applications.

Revocation lists are known for controlling the spread of viruses, for limiting the distribution and use of copyright protection-disabling software, excluding devices that have been tampered with, and the like. Security protocols that employ revocation lists include the X.509 authentication structure and the DTCP (also known as 5C) IEEE1394 link security protocol. The revocation list identifies networked machines which are regarded as security risks or are otherwise undesirable. Networked devices receive the revocation list and henceforth refuse to communicate with devices identified on the revocation list. Preferably, the revocation list is updated or supplemented on an occasional basis to account for spreading viruses, newly identified problematic devices, or the like.

Revocation lists provide relatively straightforward and effective protection against computer viruses and other information content which is widely regarded as undesirable. Revocation lists are also employed to exclude a user from having access to certain network resources, or to exclude devices from joining a communication. In the computer environment, the users of networked devices generally are cooperative in receiving and storing the revocation lists and the occasional updates or supplements to the revocation lists.

However, in certain areas, especially in the areas of music and video copyright protection and other property protection schemes, a problem arises in using revocation lists to enforce such property rights. Certain users of networked devices who want to circumvent copyright or other property protection are unlikely to cooperate in receiving the revocation data. Rather, these users are likely to attempt to block distribution of revocation lists, or to attempt to delete revocation lists that are stored on networked devices. Moreover, even users who are indifferent or favorably disposed toward the revocation lists may not receive or retain them due to the activities of viruses or other malicious software which act to block transmission and/or storage of the revocation lists.

In the past, hostility and active opposition to revocation list distribution has been countered using various approaches. In one typical revocation list distribution method, when a connection between two devices is established, the network connection protocol calls for and requires communication and storage of the revocation list (if a new or updated revocation list is being distributed) before any other action is allowed. In this way, devices are forced to receive a revocation list. A device having received a revocation list will store it and subsequently refuse to communicate with devices on that revocation list.

However, such secured network transmission protocols are not immune to the countermeasures of hackers who continually work toward developing new techniques for overcoming these network protocol-based revocation list distribution techniques. Efforts of hackers may be successful when they can readily identify the revocation list in the data stream, and because the hackers (or users of devices which have been infected by a virus or other malicious program produced and distributed by a hacker) experience no adverse consequences when the revocation list is removed from the data stream.

The present invention contemplates an improved apparatus and method that overcomes the aforementioned limitations and others.

According to one aspect, an apparatus is disclosed, including a means for storing, transmitting, or receiving a signal representing user-desired content. The signal includes the user-desired content, and device revocation information embedded in the user-desired content.

According to another aspect, a method is provided for distributing revocation information. The revocation information is embedded into user-desired content.

One advantage resides in integrating a revocation list with content desired by the user. In this manner, the user is induced to accept the revocation list as part of the desired content.

Another advantage resides in its capacity for high rate systems to communicate large revocation lists which can contain identification information pertaining to a large number of devices.

Yet another advantage resides in distributing the revocation message over a large portion of musical content or other user-desired content. In this way, the user cannot avoid receiving the revocation message by omitting a small part of the musical or other user-desired content.

Numerous additional advantages and benefits will become apparent to those of ordinary skill in the art upon reading the following detailed description of the preferred embodiments.

The invention may take form in various components and arrangements of components, in software, and in various process operations and arrangements of process operations. The drawings are only for the purpose of illustrating preferred embodiments and are not to be construed as limiting the invention.

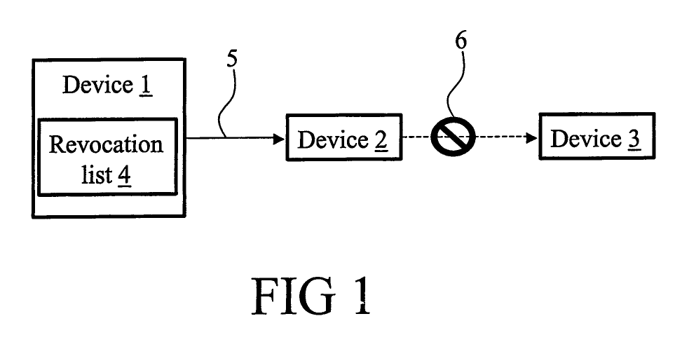

FIG. 1 shows an exemplary three networked devices and schematically illustrates transfer of a revocation list between two devices, and subsequent refusal of content transfer to the third device which is included in the revocation list.

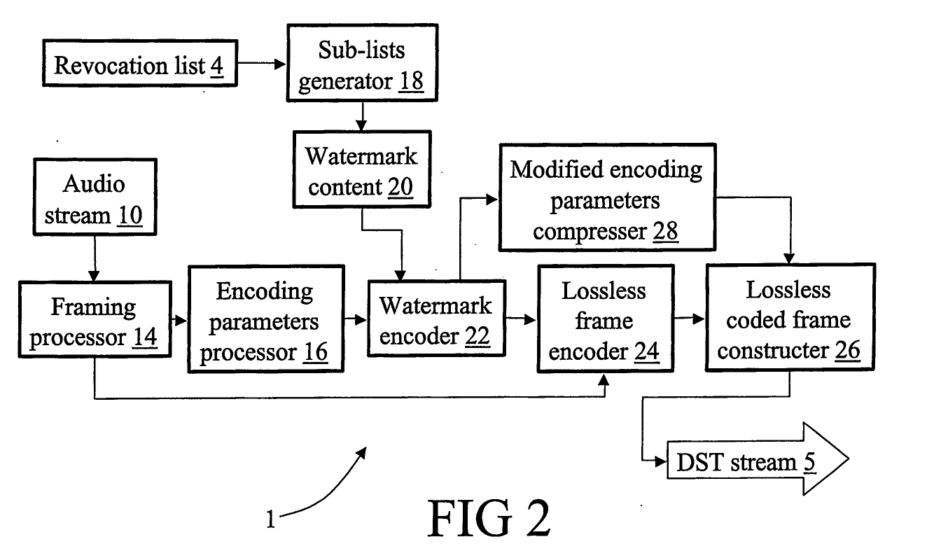

FIG. 2 schematically shows components of the device 1 that encode the user-desired content along with an embedded revocation list.

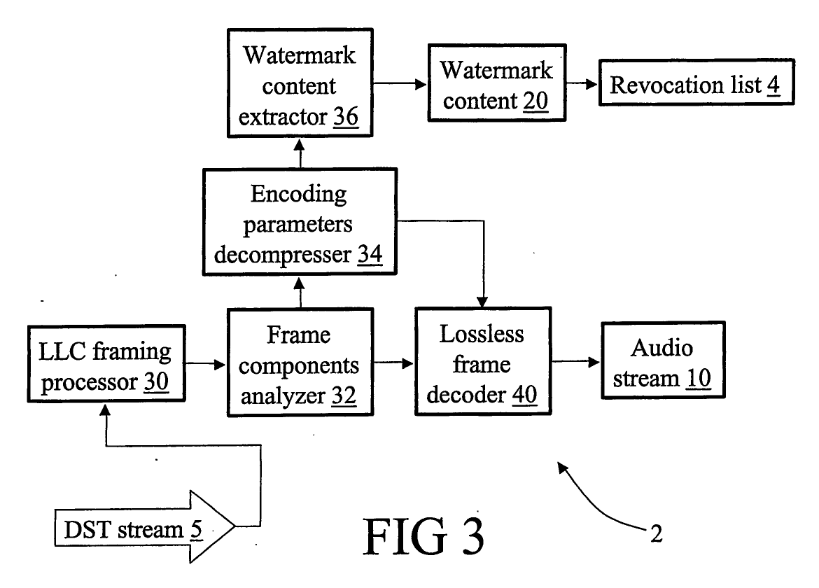

FIG. 3 schematically shows components of the device 2 that recover the revocation list and optionally decode the user-desired content.

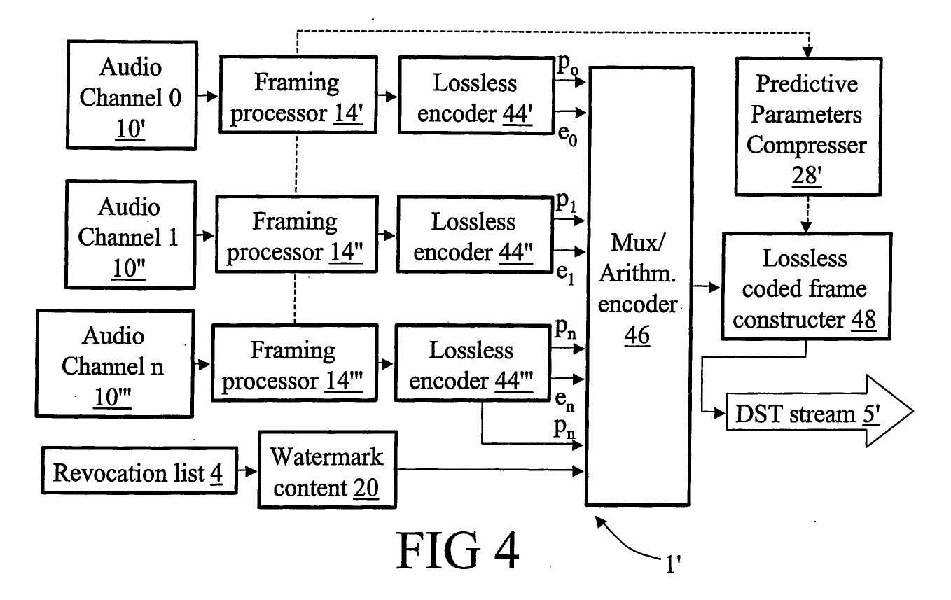

FIG. 4 schematically shows alternative components of the device 1′ that encode user-desired content along with an embedded revocation list.

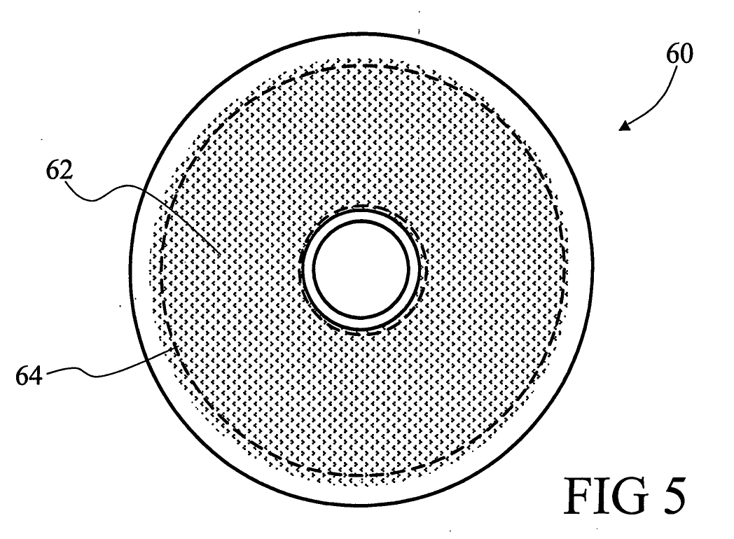

FIG. 5 schematically shows an optical compact disk which includes a digital watermark with a revocation list.

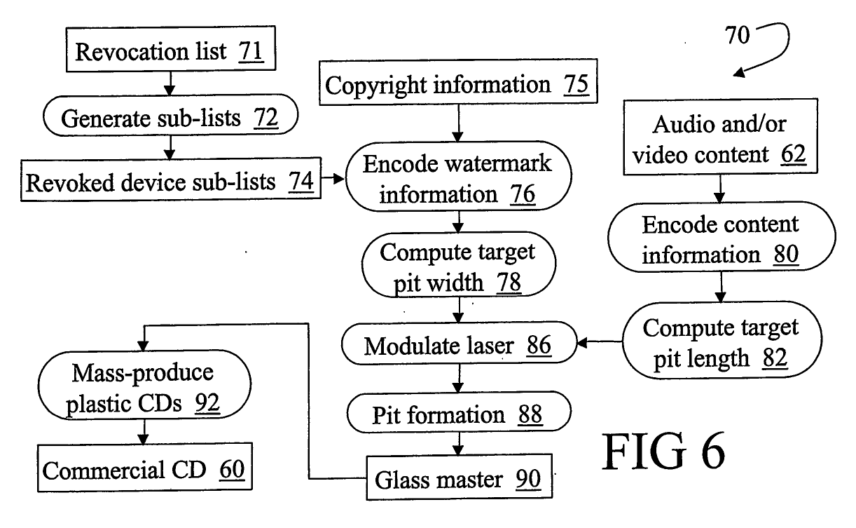

FIG. 6 shows an exemplary method for manufacturing the optical compact disk of FIG. 5.

With reference to FIG. 1, devices 1, 2, 3 communicate audio, video, or other content with one another by a suitable transfer protocol. Such transmission can be by an electronic or optical digital communication network, a wireless network such as Bluetooth, or the like. The device 1 has recently received an updated revocation list 4 that includes a revocation of the device 3.

The revocation list 4 can specify the device 3 in a variety of ways. The device 3 can be specifically revoked, that is, the device 3 is uniquely identified in the revocation list 4 as a revoked device. Alternatively, a model or manufacturer corresponding to the device 3 can be revoked. In yet another revocation arrangement, a content transfer protocol, pathway, or the like used to connect the device 3 with the devices 1, 2 can be revoked.

The device 1 communicates content 5 to the device 2. The communicated content 5 includes the revocation list 4 embedded in the content 5 in such a way that the embedded revocation list 4 is not easily removed from the content 5 or is removable only with substantial degradation of the content. Moreover, the revocation list 4 is preferably divided into sub-lists which are repeated throughout the length of content 5 so that the revocation list 4 is substantially received at the device 2 even if a small portion of the content 5 is discarded.

Subsequent to communication of the content 5, an attempt is made to initiate a transfer of content 6 from the device 2 to the device 3. However, the device 2 does not transfer content 6 in view of the updated revocation list 4 which the device 2 received in embedded form from the device 1 during transfer of content 5. The revocation list 4 identifies the device 3 as a revoked device (or identifies the device 3 as communicating with a revoked communication protocol or pathway, etc.), and so the device 2 does not communicate with the device 3.

Although audio content 5, 6 is described, the content can also be video content, data content, software, or the like. Moreover, the information can be represented or encoded in any suitable format, such as PCM, MPEG, AC3, DST, MLC, ATRAC, DivX, analog, or the like. The revocation list 4 can be embedded in the content in a suitable manner, such as by an embedded watermark, a designated audio or video channel, in a physical watermark, embedding in an analog signal, and so forth. The choice of revocation list embedding technique will depend on the type of content (audio, video, software, etc.), and the content format.

With reference to FIG. 2, in one exemplary approach the revocation list is embedded in DST encoded audio content 5 via a digital watermark that contains the revocation list 4. The watermark optionally contains additional content such as copyright information. The digital watermark does not affect the audio or other user-desired content, but also is not readily removed from the content stream 5 without decoding and reencoding the stream. In this exemplary embodiment, the device I performs lossless DST encoding of a high fidelity audio stream 10. Encoding of audio is shown by way of illustrative example, although encoding of multimedia, video, data, and the like are also contemplated. During the encoding, the revocation list 4 is embedded. The audio stream can include a plurality of audio channels, for example to transmit stereo or surround-sound audio. Moreover, instead of or in addition to an audio stream, the user-desired content could include video content, data content, or the like.

A framing processor 14 frames the audio stream 10 into data frames for lossless encoding. Preferably, if the audio stream 10 includes a plurality of audio channels, each audio channel is separately framed by the framing processor 14. In one suitable embodiment, a constant frame length of 37,362 bits per frame is used. However, different frame lengths can be used to optimally balance encoding performance and other factors. For each frame output by the framing processor 14, an encoding parameters processor 16 computes suitable encoding parameters. In typical lossless encoding schemes, the encoding parameters processor 16 computes predictive parameters that are used in the encoding to approximate the frame contents. Various filtering processes are known in the art for generating a good set of predictive parameters. Such filtering is computationally intensive, and the encoding performance is not critically dependent upon using fully optimized predictive parameters. Hence, typically the encoding parameters processor 16 computes predictive parameter values that provide efficient, but not optimal encoding performance.

Because precisely optimized values of the predictive parameters is not critical, these parameters can be modified to encode watermark content 20 without substantially degrading the efficiency of the lossless encoding. The watermark content 20 includes at least the revocation list 4. Preferably, a sub-lists generator 18 divides the revocation list into sub-lists that are distributed through the watermark content 20, and hence are ultimately distributed through the DST content stream 5. The sub-lists generator 18 optionally also duplicates the revocation list (or sub-lists thereof) to ensure that the content stream 5 has embedded revocation information extending throughout the content stream 5.

A watermark encoder 22 modifies the predictive parameters in a predetermined manner to encode the watermark content 20. For example, a least significant bit of one or more of the predictive parameters can be set to one or zero corresponding to one bit of the watermark content 20. This small change in one or a few parameter values generally does not significantly change the subsequent lossless encoding efficiency. In another suitable modification, an additional dummy predictive parameter is selectively added so that the number of predictive parameters (even or odd) corresponds with one bit of the watermark content 20. Similarly, in yet another embodiment one predictive parameter is selectively deleted so that the number of predictive parameters (even or odd) corresponds with one bit of the watermark content 20. Other predetermined modifications of the predictive parameters can be used to encode the watermark content 20.

A lossless frame encoder 24 encodes the frame using the modified predictive parameters output by the watermark encoder 22. In one suitable lossless encoding scheme, a residual is computed that corresponds to a difference between the frame value and a value predicted using the predictive parameters. For good predictive parameters, this residual contains much less relevant information, and can be efficiently encoded. The residual is suitably entropy-encoded. The encoded content along with the predictive parameters are arranged into a lossless coded frame by a lossless coded frame constructer 26. Preferably, the predictive parameters are processed by a compressor 28 using an efficient compression algorithm prior to incorporation into the lossless coded frame. The lossless coded frame includes the compressed predictive parameters, the encoded content output by the frame encoder 24, and suitable control information (for example a total number of predictive parameters and/or a frame length) in a predetermined format. The lossless coded frame enters the DST stream 5 for transmission to the device 2.

With reference to FIG. 3, the DST stream 5 is received at the device 2 and processed by a lossless coding frame processor 30 that extracts the lossless coding frames from the DST content stream 5 for decoding. A frame components analyzer 32 separates out the compressed predictive parameters and the lossless encoded data components. The compressed predictive parameters are transmitted to an encoding parameters decompressor 34 for decompression to recover the predictive parameter values. A watermark content extractor 36 recovers the watermark content 20 including the revocation list 4 from the predictive parameters. The watermark content 20 is recoverable without decoding the audio content. This allows the revocation list to be recovered even if the content stream 5 is stored in encoded form at the device 2 without immediately decoding and playing the audio content. Moreover, if the transfer rate of the content stream 5 exceeds the decoding speed, the watermark content can be extracted while the audio content is buffered for decoding.

To recover the audio content, a lossless frame decoder 40 decodes the encoded data components using the predictive parameters recovered by the parameters decompressor 34 to recover the audio stream 10.

The digital watermark content 20 including the revocation list 4 are logically integrated with the high fidelity audio stream 10. Although the DST digital watermark is typically regarded as a fragile watermark, those skilled in the art will recognize that in practice modifying the integrated DST data stream to remove the watermark while retaining a valid high fidelity audio DST stream involves a substantial amount of time, effort, and cost. Moreover, the revocation list 4 is preferably broken into independently readable sub-lists, each of which is integrated into one or a few lossless coded frames. In this way, the revocation list cannot be avoided by omitting a small amount of the content stream 5.

With reference to FIG. 4, another suitable device 1′ embeds watermark content 20 including the revocation list 4 with a multi-channel audio stream. The audio stream includes audio channel 0 10′, audio channel 1 10″, and so forth through audio channel n 10′″. Each audio channel 10′, 10″, 10′″ is processed by a framing processor 14′, 14″, 14′″ and lossless encoded through the entropy encoding stage by lossless encoders 44′, 44″, 44′″. As is known in the art, entropy encoding typically outputs the residual (eᵢ) and a probability signal (pᵢ). The residual and probability signals are multiplexed and arithmetically encoded by a MUX/arithmetic encoder 46. The predictive parameters are compressed by a compressor 28′, and combined with the multiplexed and encoded data into a lossless coded frame by a lossless coded frame constructer 48 for transfer via the content stream 5′.

To embed the watermark 20 including the revocation list 4, at least one binary bit of watermark content 20 is included as an input to the MUX/encoder 46. For encoders that require paired bit input data, the watermark bit is preferably paired with one of the probability signal bits, for example paired with the bit pₙ. At the receiving device, the DST stream 5′ is demultiplexed and arithmetically decoded to recover the watermark 20. As with the approach of FIGS. 2 and 3, the content stream 5′ does not need to be lossless decoded to recover the revocation list 4.

DST digital watermarks provide a relatively large messaging bandwidth. For an exemplary 75 frames/second transfer rate with 15 bits encoded per frame (for example, corresponding to an audio stream 10 including fifteen lossless encoded audio channels with each channel having one embedded watermark bit) a watermark transfer data rate of about 1 kbit/sec is obtained.

In a three minute song, this results in a corresponding digital watermark capacity of 180 seconds times 1 kbit/second=180 kbits or about 22 kbytes. For a typical device identifier length of 8 bytes and a signature length of 128 bytes (that is, a signature of a license authority which is typically required to demonstrate authenticity of the distributed revocation list) the portion of the digital watermark corresponding to a three minute song can encode a revocation list identifying approximately 2800 devices (that is, 22 kbytes divided by 8 bytes per device identifier).

Embodiments including embedding of revocation list information in a watermark of a DST encoded audio stream, and embedding of revocation list information using a designated audio channel of an encoded multi-channel audio stream are described herein by way of example. However, those skilled in the art can readily adapt the described embodiments for use with other types of information content and other types of encoding. For example, the embedded watermark approach is readily adapted for revocation list distribution in watermarks of encoded video streams. Similarly, an unused audio or video channel of a multimedia content stream can be used to transmit embedded revocation list information. Software and data compression technologies can similarly incorporate embedded revocation lists. Revocation list information can be incorporated as a dedicated “mute” audio channel of DVD video. The mute channel is encoded using PCM, MPEG, AC3, or another audio encoding supported by DVD, and is ignored when the DVD is played. However, this approach has a disadvantage if the encoding is computationally complex in that the watermark is usually not recoverable without fully decoding the audio content. Meridian lossless packing (MLP) lossless encoding, which has been selected for DVD-audio, is readily adapted for embedding a revocation list.

In these embedding methods, the revocation list is preferably divided into revocation device sub-lists that are distributed substantially co-extensively with the video or audio content. The lists can be redundantly repeated multiple times so that the user cannot avoid the revocation list by omitting receipt, playback or other accessing of a limited portion of the user-desired programming.

With reference to FIG. 5, yet another exemplary embodiment, in which a revocation list is embedded in a digital watermark of an optical compact disk 60, is described. The optical compact disk 60 can be a DVD type of disc including high fidelity audio content 62 that is encoded by optically reflective pits disposed on or in the disk 60. The reflective pits encoding the high fidelity content 62 extend across and substantially fill a central portion of the compact disk 60. The region of high fidelity audio content 62 is represented by texturing in FIG. 5. In a suitable encoding, the high fidelity audio content 62 is encoded in the lengths of the optically reflective pits while the digital watermark 64 is encoded in pit widths.

The watermark 64 is preferably substantially coextensive with the high fidelity audio content 62. In FIG. 5, an exemplary spatial extent of encoded data of the digital watermark 64 on the disk 60 is schematically indicated by inner and outer dashed circumferential boundary lines. The watermark 64 includes a revocation list which is preferably divided into redundantly replicated sub-lists distributed throughout the disk 60. The watermark 64 optionally also includes other information such as copyright information In operation, a user plays high fidelity audio content 62 of the compact disk 60 on a playback device (not shown). If the playback device is a compliant device respective to the revocation list, the playback device simultaneously reads the watermark 64 during playback of the high fidelity audio content 62. If the revocation list contained in the watermark 64 post-dates any revocation lists currently stored on the compliant playback device, the revocation list of the watermark 64 replaces the older stored revocation list.

Although an exemplary optical disk 60 is described here, revocation information can similarly be distributed by distributing other non-volatile storage media on which is stored user-desired content with the embedded revocation information. For example, solid-state non-volatile memory units, magnetic disks, and the like on which the user-desired content with embedded revocation information is stored can be distributed.

With reference to FIG. 6, a suitable method 70 for mass-producing the optical compact disk 60 is described. A revocation list 71 is divided 72 into a plurality of revoked device sub-lists 74. The device sub-lists 74 are optionally combined with copyright information 75 or other additional watermark content, and the watermark information is encoded 76 and a target reflective pit width is computed 78. Similarly, the high fidelity audio content 62 is encoded 80 and a target reflective pit length is computed 82.

The computed target pit length and width are used to modulate 86 a laser that records the reflective pits that encode the high fidelity audio data stream. The pits are formed 88 on a glass substrate disk to define a glass master 90. The glass master 90 is used to mass-produce 92 commercial optical compact disks, such as the disk 60, which are usually plastic disks with reflective optical coatings. Optionally, the mass-production 92 further includes formation of a conventional redbook layer for backward compatibility with older CD players.

Preferably, the revocation list 71 is updated on an occasional or more frequent basis by producing an updated glass master 90 in accordance with the relevant process operations of the method 70. The revocation list 71 is updated, for example, to include new devices that have been identified as being non-compliant with the selected content reproduction management protocol. In this manner, the compact disk manufacturer continually produces compact disks with music offerings that contain up-to-date revocation lists.

Compliant devices automatically receive an updated revocation list each time a new compact disk containing updated or supplementary revocation list information is played.

Embodiments embedding revocation information into audio streams and into physical medium watermarks have been described. However, it will be appreciated that revocation information can be similarly embedded and distributed by other devices or media which transmit, receive, or store various types of user-desired audio, video, data, software, or other content. Employment of less fragile digital watermarks than the DST watermarks described herein makes it more difficult to remove the embedded revocation list. However, less fragile digital watermarks typically have less data capacity and hence can store fewer revoked device identifications. Moreover, instead of using a digital watermark, the revocation information can be encoded in a mute channel or other pathway provided by the encoding technology and comporting with the type of content being processed.

The invention has been described with reference to the preferred embodiments. Obviously, modifications and alterations will occur to others upon reading and understanding the preceding detailed description. It is intended that the invention be construed as including all such modifications and alterations insofar as they come within the scope of the appended claims or the equivalents thereof.

Having thus described the preferred embodiments, the invention is now claimed to be:

1. An apparatus including:
a means (1, 1′,2, 60) for storing, transmitting, or receiving a signal (5,5′) representing user-desired content, the signal including:
the user-desired content (10, 10′, 10″, 10′″, 62), and
device revocation information (4, 71) embedded in the user-desired content.

2. The apparatus as set forth in claim 1, wherein the means (1, 1′, 2, 60) for storing, transmitting, or receiving includes a means (1, 1′) for transmitting, and the means (1; 1′) for transmitting includes:
a means (18) for generating watermark content (20) associated with the user-desired content, the watermark content (20) including the device revocation information (4).

3. The apparatus as set forth in claim 2, wherein the means (1,1′) for transmitting further includes:
a means (14, 14′, 14″, 14′″, 16, 24, 26, 44, 44′, 44″, 44′″) for encoding the user-desired content (10, 10′, 10″, 10′″); and
a means (22, 46) for embedding the watermark content (20) into the encoded user-desired content as an embedded watermark.

4. The apparatus as set forth in claim 1, wherein the means (1, 1′, 2, 60) for storing, transmitting, or receiving includes a means (2) for receiving, and the means (2) for receiving includes:
a means (32, 34, 36) for reading an embedded watermark (20) included in the signal (5) representing the user-desired content (10), the embedded watermark including the device revocation information (4).

5. The apparatus as set forth in claim 4, wherein the means (2) for receiving further includes:
a means (32, 34, 40) for recovering the user-desired content (10) from the signal (5).

6. The apparatus as set forth in claim 1, wherein the means (1, 1′, 2, 60) for storing, transmitting, or receiving includes a means (60) for storing selected from a group consisting of:
an optical disk (60), a magnetic disk, and a non-volatile solid-state memory.

7. The apparatus as set forth in claim 1, wherein the device revocation information (4, 71) is arranged into a plurality of independent revocation sub-lists (74) that are distributed across the user-desired content (10, 10′, 10″, 10′″, 62).

8. The apparatus as set forth in claim 7, wherein the device revocation information (4, 71) is encoded pervasively through the user-desired content (10, 10′, 10″, 10′″, 62).

9. The apparatus as set forth in claim 1, wherein the device revocation information (4, 71) is encoded into a watermark (20, 64).

10. The apparatus as set forth in claim 1, wherein the means (1, 1′, 2, 60) for storing, transmitting or receiving stores, transmits or receives a signal (5, 5′) including the user-desired content arranged in a format selected from a group consisting of: PCM, MPEG, AC3, DST, MLC, ATRAC, DivX, and analog.

11. The apparatus as set forth in claim 1, wherein the user-desired content includes digital video content, and the device revocation information is embedded in the digital video.

12. The apparatus as set forth in claim 1, wherein the means (1, 1′, 2, 60) for storing, transmitting, or receiving includes a means (60) for storing which includes a non-volatile storage medium (60) on which the user-desired content (62) is encoded as a selected modulation of a property of the storage medium material, the selected modulation including a first modulation aspect (82) encoding the user-desired content (62) and a second modulation aspect (78) encoding the device revocation information (71).

13. The apparatus as set forth in claim 12, wherein the non-volatile storage medium (60) is an optical disk (60), the selected modulation includes reflective pits formed on or in the optical disk, and the first and second modulation aspects include pit characteristics.

14. The apparatus as set forth in claim 1, wherein the means (1, 1′, 2, 60) for storing, transmitting, or receiving includes a means (1) for transmitting which includes:
a framing means (14) for framing the user-desired content (10);
a parameter computing means (16) for computing predictive parameters for each frame;
a means (22) for modifying the predictive parameters to embed the device revocation information (4); and
an encoding means (24) for encoding the frame using the modified predictive parameters.

15. The apparatus as set forth in claim 1, wherein the means (1, 1′, 2, 60) for storing, transmitting, or receiving includes a means (2) for receiving which includes:
a parameter extracting means (32, 34) for extracting predictive parameters of a lossless coded frame that encodes the user-desired content (10); and
a means (36) for recovering the device revocation information (4) encoded in the predictive parameters.

16. The apparatus as set forth in claim 1, wherein the user-desired content is a multi-channel audio stream (10′, 10″, 10′″), and the means (1, 1′, 2, 60) for storing, transmitting, or receiving includes a means (1′) for transmitting which includes:
a means (14′, 14″, 14′″, 44′, 44″, 44′″) for lossless coding each audio channel; and
a means (46, 48) for combining lossless coded data corresponding to the multiple channels into lossless coded frames, the means for combining embedding the device revocation information (4) into the lossless coded frames.

17. A method for distributing revocation information (4), the method including:
embedding the revocation information (4) into user-desired content (10, 10′, 10″, 10′″).

18. The method as set forth in claim 17, wherein the embedding includes:
dividing a list of revoked devices into a plurality of sub-lists; and
embedding each sub-list into the user-desired content such that the sub-lists are substantially coextensive with the user-desired content.

19. The method as set forth in claim 17, wherein the embedding includes:
generating watermark content (20) including the device revocation information (4); and
embedding the watermark content (20) into user-desired content as an embedded watermark.

20. The method as set forth in claim 19, wherein the embedding further includes:
encoding the user desired content (10, 10′, 10″, 10′″), the watermark content being embedded into the user-desired content during the encoding.

21. The method as set forth in claim 17, wherein the embedding includes:
embedding the revocation information (4) pervasively through the user-desired content (10, 10′, 10″, 10′″).

22. The method as set forth in claim 17, wherein the embedding includes:
selecting predictive parameters for encoding the user-desired content (10);
modifying the predictive parameters to encode at least a portion of the revocation information (4) in a predetermined manner; and
lossless encoding at least a portion of the user-desired content (10) using the modified predictive parameters.

23. The method as set forth in claim 17, wherein the user-desired content is a multi-channel audio stream (10′, 10″, 10′″), and the embedding includes:
lossless coding each audio channel (10′, 10″, 10′″); and
combining lossless coded data corresponding to the multiple channels (10′, 10″, 10′″) into lossless coded frames, the combining also embedding the device revocation information (4) into the lossless coded frames.

24. The method as set forth in claim 17, further including:
communicating the user-desired content (10, 10′, 10″, 10′″) and the embedded revocation information (4) simultaneously.

25. The method as set forth in claim 24, further including:
extracting the revocation information (4) from the communicated user-desired content (10).

26. The method as set forth in claim 25, wherein the extracting includes:
extracting an embedded watermark (20) from a received data stream (5); and
extracting the device revocation information (4) from the watermark (20).

27. The method as set forth in claim 25, wherein the communicated user-desired content (10) is lossless coded, and the extracting includes:
extracting predictive parameters of a lossless coded frame; and recovering the revocation information (4) encoded in the predictive parameters.

28. The method as set forth in claim 24, wherein the communicating includes:
distributing a non-volatile storage medium (60) on which is stored the user-desired content with the embedded revocation information.
